(19) United States
(12) Patent Application Publication
(10) Pub. No.: US 2008/0147228 A1
(43) Pub. Date: Jun. 19, 2008

(54) Automated dynamic recipe generation and selection for semiconductor manufacturing

(76) Inventors: Joel S. Fenner, Hillsboro, OR (US); Brian S. Kinnear, Hillsboro, OR (US); Steven L. Carson, Portland, OR (US); Vincent A. Pagano, Chandler, AZ (US)

Correspondence Address: INTEL/BLAKELY, 1279 OAKMEAD PARKWAY, SUNNYVALE, CA, 94085-4040, US

(21) Appl. No.: 11/642,577

(22) Filed: Dec. 19, 2006

(51) Int. Cl. G06F 17/00

(52) U.S. Cl. 700/121

(57) ABSTRACT

In one embodiment, an apparatus and method for automated dynamic recipe generation and selection for semiconductor manufacturing are disclosed. In one embodiment, the method comprises: receiving a lot at a tool of a semiconductor manufacturing system; making, by a host controller for the tool, a lookup recipe call to an automated dynamic recipe generation and selection (ADRS) system; running, by the ADRS system, logic scripts to create a unique recipe instruction set for the particular tool and lot, the logic scripts to utilize at least one of results from past runs associated with the tool, historical statistical process control (SPC) system analysis results, and a context of the lookup recipe call in order to create the unique recipe instruction set; and returning the unique recipe instruction set to the host controller to be run by the tool on the lot.

### FIELD OF THE INVENTION

The embodiments of the invention relate generally to the field of semiconductor fabrication and, more specifically, relate to automated dynamic recipe generation and selection for semiconductor manufacturing.

### BACKGROUND

In semiconductor manufacturing, there are many variables that lead to the need to use a different recipe instruction set (set of instructions to the tool) at a particular semiconductor manufacturing operation. The recipe instruction set includes the tool recipe name (tool recipe is set of instructions to the tool) and other key parameters that affect processing and/or measuring of the material at a given manufacturing operation. In operation, this recipe string is passed to the host controller of the tool it is to be run on and then parsed by this controller. The parsing may result in a name of the recipe, further instructions for processing around the tool, and the actual set of instructions for processing on the tool.

In the past, the determination of the recipe instruction set was done by a static (or fixed) recipe correlation table. This static recipe correlation table is a flat lookup table that is based on key static context information. For example, the look up recipe may be determined from the table by standard set of potentially wild-carded contexts, including, for instance, product, operation, tool, entity, and so on. In operation, this static system is restrictive in its operation to specify recipe strings (i.e., instruction sets) because a fixed set of contexts is needed to obtain a recipe.

Furthermore, the utilization of a single table can result in many thousands of rows existing in this table. Such a configuration can result in a burdensome and time-consuming determination of the recipe string for the tool. The information stored in the table can be redundant and difficult to configure, as all scenarios and combinations should be accounted for. A system for performing a dynamic determination of the recipe instruction set for a semiconductor manufacturing tool without relying on a static lookup table would be beneficial.

### BRIEF DESCRIPTION OF THE DRAWINGS

The invention will be understood more fully from the detailed description given below and from the accompanying drawings of various embodiments of the invention. The drawings, however, should not be taken to limit the invention to the specific embodiments, but are for explanation and understanding only.

FIG. 1 illustrates a block diagram of one embodiment of a semiconductor manufacturing system;

FIG. 2 is a flow diagram of one embodiment of a method of an automated dynamic recipe generation and selection (ADRS) system;

FIG. 3 is a flow diagram of one embodiment of a method for a lookup call of an ADRS system;

FIG. 4 is a flow diagram of one embodiment of a method for a send SPC decision call of an ADRS system; and

FIG. 5 illustrates a block diagram of one embodiment of a computer system.

### DETAILED DESCRIPTION

A method and apparatus for automated dynamic recipe generation and selection for semiconductor manufacturing are described. In the following detailed description of the present invention, numerous specific details are set forth in order to provide a thorough understanding of the present invention. However, it will be apparent to one skilled in the art that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

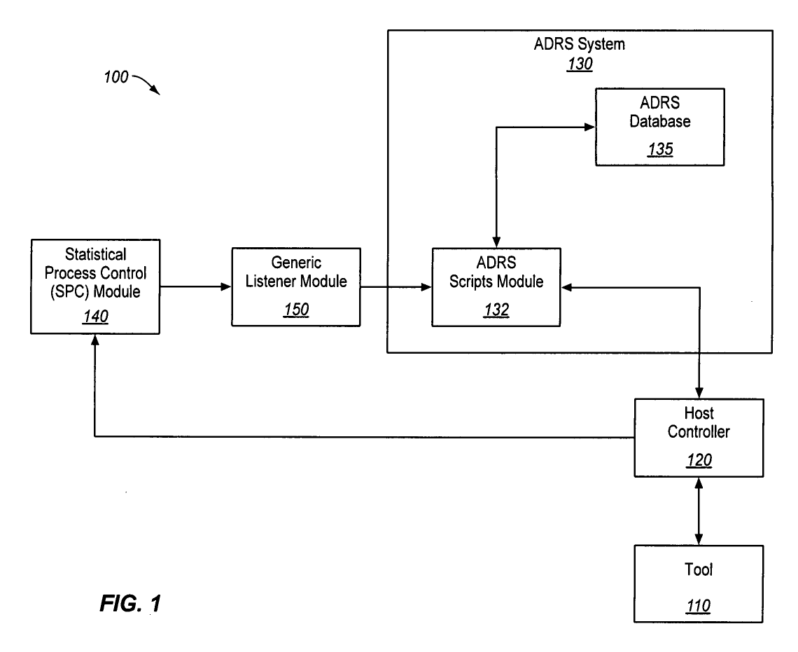

Embodiments of the invention provide for automated dynamic recipe generation and selection (ADRS) for semiconductor manufacturing. FIG. 1 is a block diagram of one embodiment of a semiconductor manufacturing system where embodiments of the invention may operate. System 100 includes a manufacturing tool 100, a host controller 110, an ADRS system 130, a statistical process control (SPC) module 140, and a generic listener module 150.

Manufacturing tool 110 receives one or more lots of wafers and performs various processes on these lots to contribute to the production of a finalized semiconductor. Host controller 120 directs the operations of tool 110. For example, host controller 120 may be adapted to automatically control the operating recipe for tool 110.

ADRS system 130 is the component of embodiments of the invention that provides for the dynamic determination of recipe instruction sets (i.e., recipe strings) to be sent to tool 110. ADRS system 130 further includes an ADRS scripts module 132 and an ADRS database 135. ADRS scripts module 132 includes multiple configurable scripts to be run to provide dynamic determination of recipe strings for the tool 110 based on a variety of factors. ADRS database 135 is a storage location that stores information such as a history of previous measurements associated with the tool and its prior lots and pass/fail information associated with the tool and its prior lots.

SPC module 140 implements algorithms to achieve quality control in the manufacturing processes performed by tool 110. It provides a set of methods using statistical tools such as mean, variance and others, to detect whether the process observed is under control. Generic listener module 150 listens to published reports from the SPC module 140 and conveys the information back to the ADRS system 130 for the ADRS system's own assessment.

The ADRS system of embodiments of the invention, such as ADRS system 130 of FIG. 1, improves on the current state of the art by implementing some important capabilities. One capability is to allow dynamic selection of a recipe instruction set to be based on items besides just context information. For instance, the process technology may be an important variable because it determines the tolerances in the recipe, but this is not directly passed as context in the lookup.

Another capability includes allowing for dynamic selection of the recipe instruction set to be based on business-use cases. For instance, if a material is re-introduced at a process tool due to failure on the first introduction, then an alternate recipe instruction set is used. An additional capability is enabling intelligent metrology sampling. For instance, if material is re-measured at a metrology tool due to a failure of a first pass, then a recipe instruction set with denser sampling may be used.

A further capability is allowing for dynamic selection of recipe instruction set parameters based on different criterion. In other words, one segment of the recipe instruction set may be based on one aspect or criteria, while another segment of the recipe instruction set is based on another aspect or criteria. For example, process technology may be useful for determining the tolerance of the recipe instruction set, while the business-use case is useful for determining the level of sampling in the recipe instruction set.

The ADRS system of embodiments of the invention implements these new capabilities through the configurable use of a series of lookups to determine the keys of the lookups (e.g., map context to items of interest), leveraging of information on the use case, and tighter integration with other automation systems (e.g., results of SPC decisions). Then, embodiments of the invention use this information to lookup parts of the recipe instruction set. Finally, the entire recipe instruction set is dynamically constructed from the various portions of the recipe instruction set that were previously determined.

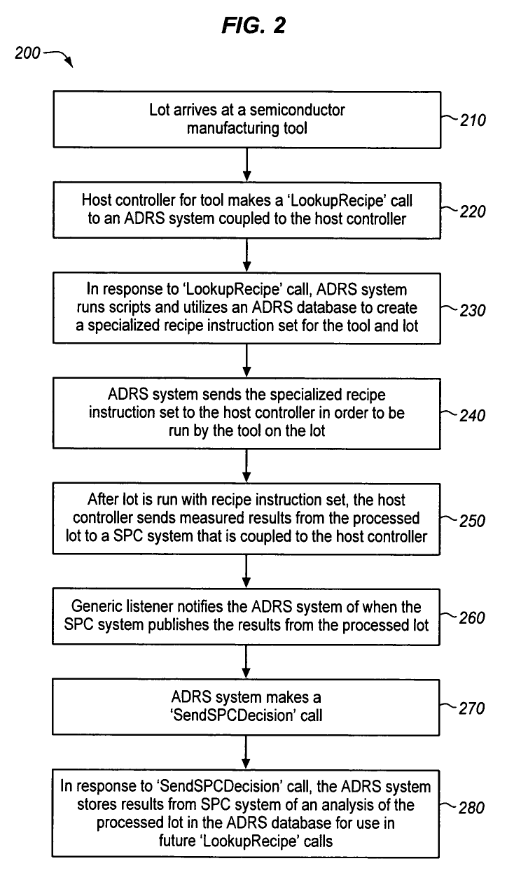

FIG. 2 is a flow diagram illustrating a method of ADRS according to one embodiment of the invention. In one embodiment, the system 100 described with respect to FIG. 1 performs the process 200 of FIG. 2. Dynamic recipe selection for a semiconductor manufacturing tool is achieved by making two calls to a recipe selection system (i.e., ADRS system). These calls are depicted as part of the overall process 200 of embodiments of the invention.

Process 200 begins at processing block 210, where a lot arrives at a semiconductor manufacturing tool. At processing block 220, a host controller for the tool makes a lookup recipe call (e.g., ‘LookupRecipe’) to an ADRS system coupled to the host controller. This ‘LookupRecipe’ call ultimately returns a recipe instruction set to the host controller for use by the tool in processing the lot.

At processing block 230, the ‘LookupRecipe’ call results in the ADRS system running scripts and utilizing an ADRS database to create a specialized recipe instruction set for the tool and lot. As processing block 240, this recipe instruction set is sent to the host controller in order to be run by the tool on the lot. After the lot is run with the recipe instruction set, the host controller sends measured results from the processed lot to a SPC system that is coupled to the host controller at processing block 250.

At processing block 260, a generic listener notifies the ADRS system of when the SPC system publishes the results from the processed lot. Then, at processing block 270, the ADRS system makes a send SPC decision (e.g., ‘SendSPCDecision’) call. Finally, at processing block 280, the ‘SendSPCDecision’ call results in the ADRS system to store the SPC results from the analysis of the processed lot in the ADRS database for use in future ‘LookupRecipe’ calls.

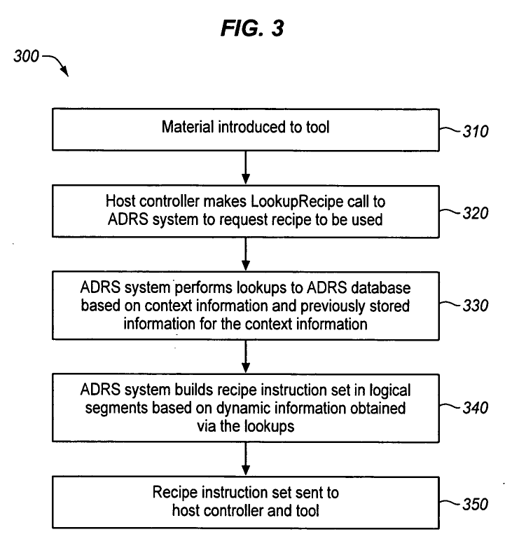

FIG. 3 is a flow diagram depicting a method for the lookup recipe call (e.g., ‘LookupRecipe’) of embodiments of the invention. Process 300 depicts one embodiment of a method for a host controller of a tool to call an ADRS system in order to request a recipe instruction set to use at a tool. In one embodiment, this process may be utilized at processing blocks 220 and 230 of FIG. 2.

Process 300 begins at processing block 310, where a material is introduced at a tool of a semiconductor manufacturing line. At processing block 320, a host controller for the tool makes a ‘LookupRecipe’ call to an ADRS system coupled to the host controller in order to receive a recipe instruction set for the tool.

Then, at processing block 330, the ADRS system is triggered by the ‘LookupRecipe’ call to perform a series of lookups. These lookups are based on the context information of the particular processing scenario (e.g., lot, route, product, operation, entity, etc.) and previously stored information relating to the processing scenario (e.g., history of previous measurements taken, pass/fail information from SPC, etc.).

At processing block 340, the ADRS system builds a recipe instruction set in logical segments based on the dynamic and intelligent lookups. The configuration space needed in the ADRS system is smaller than prior art systems because the recipe instruction set may be built up in these logical segments based on the dynamic information determined by the ADRS system. Finally, at processing block 350, the recipe instruction set is sent to the host controller for use by the tool.

In some embodiments, when the ADRS system is generating a recipe instruction set via the ‘LookupRecipe’ call, it may utilize multiple database object lookups that are stored in the ADRS database. The below listing illustrates one embodiment of exemplary configurable database objects that may be utilized for a ‘LookupRecipe’ call in an ADRS system:
1. ADRS_DEVICE MODEL—Lookup to find the device for the given lot.
2. ADRS_MULTIMASK MODEL—This table holds alignment and calculation information for lots that have more than one measurement.
3. ADRS_RECIPE MODEL—This table holds the recipe information including the ability to override the normal setup for the recipe.
4. ADRS_RECIPE_SUFFIX MODEL—Lookup the suffix used for the recipe based on the recipe precedence.
5. ADRS_SKIP_{—}3WAFER MODEL—Lots that match a record in this table will skip the 3 wafer measurement and force a full lot measure.
6. ADRS_TESTNAME MODEL—Determines the test name (which is sent to SPC to determine appropriate configuration of data collection and charting) and whether this is this is a full loop or short loop.
7. ADRS_TESTNAME_SUFFIX MODEL—This table contains the suffix added to the end of the test name based on whether the lot is a full lot measure.
8. ADRS_TOLERANCE MODEL—This table contains the tolerance used in some overlay specific metrology analysis algorithms.
9. ADRS_W_TOKEN MODEL—If the lot matches a record in this table that W Token will be used. If the W token is in the RCT string, the automatic on-line overlay modeling and analysis program will invert the resulting data set. This is used when a litho layer puts down the outer box instead of the inner box for the box-in-box reg metro structure.
10. ADRS_FULL_LOT_MEASURE LOOKUP—If a lot is on this table, the lot will be forced to a full lot measurement.
11. ADRS_REG LOT—This is the lot table for containing the information on the lot running previously through the operation.
12. ADRS_CONFIG LOOKUP—This table contains configuration information for the application, in this case only the limit for small lots.
13. ADRS_SCRIPT—Script table to determine which script and method to run for each job_type.

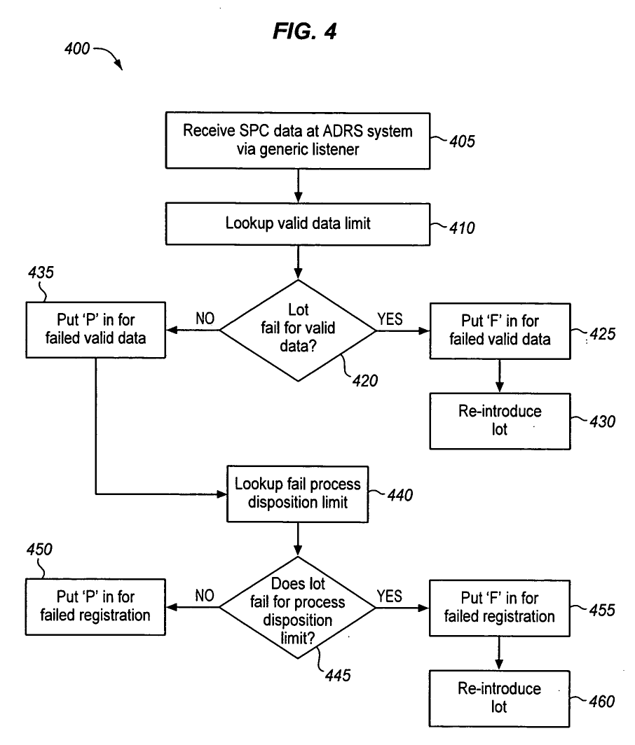

FIG. 4 is a flow diagram depicting a method for the send SPC decision call (e.g., ‘SendSPCDecision’) of embodiments of the invention. Process 400 depicts one embodiment for an ADRS system of embodiments of the invention to store information relating to the processing of a particular context at a tool for future use in determining a recipe instruction set. In one embodiment, this process may be utilized at processing blocks 270 and 280 of FIG. 2. As discussed with respect to FIG. 2, the ‘SendSPCDecision’ call is triggered in the ADRS system through a generic listener that determines when a SPC system associated with the ADRS system has published results from processing at a tool.

Process 400 begins at processing block 405, where the ADRS system listens to material published from a separate SPC system. The SPC system communicates whether an SPC decision related to processing at a tool is a pass or fail decision. As mentioned above, this information is stored for later use in determining a future recipe instruction set in the same or similar context (e.g., failure indicates need to measure more wafers).

At processing block 410, a data limit for valid data is determined. Then, at decision block 415, it is determined whether the information published for the lot indicates if the lot failed for valid data. If the lot did fail for valid data, then at processing block 425, the ADRS system marks an ‘F’ for failed in a failed valid data indication area. At processing block 430, the lot is then re-introduced at the tool. The ADRS system of embodiments of the invention will then utilize the fail data in its system in determining a different and unique recipe instruction set for the tool and lot.

However, if the lot did not fail for valid data, a ‘P’ for passed is marked in the valid data indication area at processing block 435. Subsequently, at processing block 440, a fail process disposition limit for the lot is determined. Then, at decision block 445, it is the ADRS system determines whether the lot failed for a determined process disposition threshold. If the lot did not fail in decision block 445, then a ‘P’ for pass is marked in the failed registration indication area.

However, if the lot did fail in decision block 450, a ‘F’ for fail is marked in the failed registration indication area at processing block 455. Then, at processing block 460, the lot is re-introduced. The ADRS system of embodiments of the invention will then utilize the fail data in its system in determining a different and unique recipe instruction set for the tool and lot.

One skilled in the art will appreciate that various other processing methodologies may be performed in relation to processes 300 and 400. Processes 300 and 400 are not necessarily limited to the particular order of processing blocks specifically depicted above.

In one example embodiment, the ADRS concept may be applied to an overlay metrology tool automated recipe selection (OARS). Overlay tools typically have thousands of configured recipes that are very difficult to maintain. In some embodiments, these configured recipes may be reduced to approximately 100 configuration rows. Additionally, the OARS application may allow for elimination of various human decisions in the usual flow, which leads to a less error-prone and more streamlined processing.

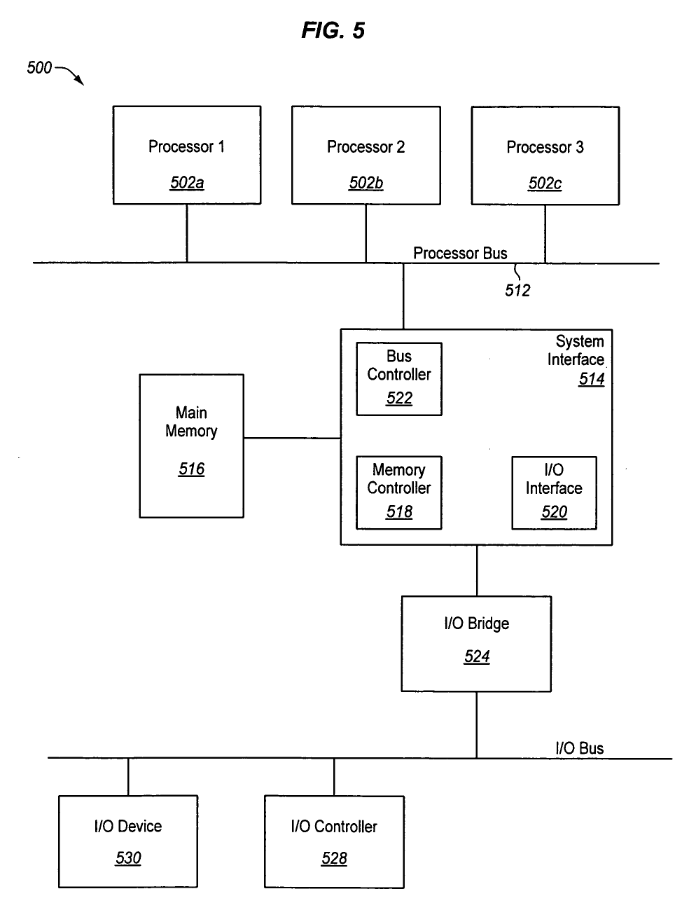

FIG. 5 is a block diagram illustrating an exemplary computer system (system) 500 used in implementing one or more embodiments of the invention. Some components of FIG. 1 may be implemented as system 500 or as components of system 500. System 500 includes one or more processors 502a-c. The processors 502a-c may include one or more single-threaded or multi-threaded processors. A typical multi-threaded processor may include multiple threads or logical processors, and may be capable of processing multiple instruction sequences concurrently using its multiple threads.

Processors 502a-c may also include one or more internal levels of cache and a bus controller or bus interface unit to direct interaction with the processor bus 512. As in the case of chip multiprocessors or multi-core processors, processors 502a-c may be on the same chip. The chip may include shared caches, interprocessor connection networks, and special hardware support such as those for SPT execution (not shown). Furthermore, processors 502a-c may include multiple processor cores. Processor bus 512, also known as the host bus or the front side bus, may be used to couple the processors 502a-c with the system interface 514.

System interface 514 (or chipset) may be connected to the processor bus 512 to interface other components of the system 500 with the processor bus 512. For example, system interface 514 may include a memory controller 518 for interfacing a main memory 516 with the processor bus 512. The main memory 516 typically includes one or more memory cards and a control circuit (not shown). System interface 514 may also include an input/output (I/O) interface 520 to interface one or more I/O bridges or I/O devices with the processor bus 512. For example, as illustrated, the I/O interface 520 may interface an I/O bridge 524 with the processor bus 512. I/O bridge 524 may operate as a bus bridge to interface between the system interface 514 and an I/O bus 526. One or more I/O controllers and/or I/O devices may be connected with the I/O bus 526, such as I/O controller 528 and I/O device 530, as illustrated. I/O bus 526 may include a peripheral component interconnect (PCI) bus or other type of I/O bus.

System 500 may include a dynamic storage device, referred to as main memory 516, or a random access memory (RAM) or other devices coupled to the processor bus 512 for storing information and instructions to be executed by the processors 502a-c. Main memory 516 may also be used for storing temporary variables or other intermediate information during execution of instructions by the processors 502a-c. System 500 may include a read only memory (ROM) and/or other static storage device coupled to the processor bus 512 for storing static information and instructions for the processors 502a-c.

Main memory 516 or dynamic storage device may include a magnetic disk or an optical disc for storing information and instructions. I/O device 530 may include a display device (not shown), such as a cathode ray tube (CRT) or liquid crystal display (LCD), for displaying information to an end user. I/O device 530 may also include an input device (not shown), such as an alphanumeric input device, including alphanumeric and other keys for communicating information and/or command selections to the processors 502a-c. Another type of user input device includes cursor control, such as a mouse, a trackball, or cursor direction keys for communicating direction information and command selections to the processors 502a-c and for controlling cursor movement on the display device.

System 500 may also include a communication device (not shown), such as a modem, a network interface card, or other well-known interface devices, such as those used for coupling to Ethernet, token ring, or other types of physical attachment for purposes of providing a communication link to support a local or wide area network, for example. Stated differently, the system 500 may be coupled with a number of clients and/or servers via a conventional network infrastructure, such as a company's intranet and/or the Internet, for example.

It is appreciated that a lesser or more equipped system than the example described above may be desirable for certain implementations. Therefore, the configuration of system 500 may vary from implementation to implementation depending upon numerous factors, such as price constraints, performance requirements, technological improvements, and/or other circumstances.

The benefits of ADRS concept when applied to recipe generation and selection include many advantages. One advantage is a fewer number of entries to configure via a series of intelligent lookups that use a wider array of dynamic information, rather than just one lookup on a small set of fixed contexts. Another advantage is less mis-processing risk through elimination of manual decisions by technicians.

An additional advantage is that in the case of logic that does not fit into traditional flat recipe correlation lookups, the scriptable logic of embodiments of the ADRS concept allow for automation of these manual decisions. A further advantage is improved quality due to less manual decision making. Other additional advantages include improved flexibility for changing technology needs, more pertinent data used in the recipe selection decision (e.g., previous failures for the lot may be used to determine recipe), and an enablement of intelligent metrology sampling that allows for faster throughput.

It should be noted that, while the embodiments described herein may be performed under the control of a programmed processor, such as processors 502a-c, in alternative embodiments, the embodiments may be fully or partially implemented by any programmable or hard coded logic, such as field programmable gate arrays (FPGAs), transistor transistor logic (TTL) logic, or application specific integrated circuits (ASICs). Additionally, the embodiments of the invention may be performed by any combination of programmed general-purpose computer components and/or custom hardware components. Therefore, nothing disclosed herein should be construed as limiting the various embodiments of the invention to a particular embodiment wherein the recited embodiments may be performed by a specific combination of hardware components.

In the above description, numerous specific details such as logic implementations, opcodes, resource partitioning, resource sharing, and resource duplication implementations, types and interrelationships of system components, and logic partitioning/integration choices may be set forth in order to provide a more thorough understanding of various embodiments of the invention. It will be appreciated, however, to one skilled in the art that the embodiments of the invention may be practiced without such specific details, based on the disclosure provided. In other instances, control structures, gate level circuits and full software instruction sequences have not been shown in detail in order not to obscure the invention. Those of ordinary skill in the art, with the included descriptions, will be able to implement appropriate functionality without undue experimentation.

The various embodiments of the invention set forth above may be performed by hardware components or may be embodied in machine-executable instructions, which may be used to cause a general-purpose or special-purpose processor or a machine or logic circuits programmed with the instructions to perform the various embodiments. Alternatively, the various embodiments may be performed by a combination of hardware and software.

Various embodiments of the invention may be provided as a computer program product, which may include a machine-readable medium having stored thereon instructions, which may be used to program a computer (or other electronic devices) to perform a process according to various embodiments of the invention. The machine-readable medium may include, but is not limited to, floppy diskette, optical disk, compact disk-read-only memory (CD-ROM), magneto-optical disk, read-only memory (ROM) random access memory (RAM), erasable programmable read-only memory (EPROM), electrically erasable programmable read-only memory (EEPROM), magnetic or optical card, flash memory, or another type of media/machine-readable medium suitable for storing electronic instructions. Moreover, various embodiments of the invention may also be downloaded as a computer program product, wherein the program may be transferred from a remote computer to a requesting computer by way of data signals embodied in a carrier wave or other propagation medium via a communication link (e.g., a modem or network connection).

Similarly, it should be appreciated that in the foregoing description, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as the invention.

What is claimed is:

1. A method, comprising:
receiving a lot at a tool of a semiconductor manufacturing system;
making, by a host controller for the tool, a lookup recipe call to an automated dynamic recipe generation and selection (ADRS) system;
running, by the ADRS system, logic scripts to create a unique recipe instruction set for the particular tool and lot, the logic scripts to utilize at least one of results from past runs associated with the tool, historical statistical process control (SPC) system analysis results, and a context of the lookup recipe call in order to create the unique recipe instruction set; and
returning the unique recipe instruction set to the host controller to be run by the tool on the lot.

2. The method of claim 1, further comprising:
sending processing results from running the lot on the tool to the SPC system;
determining by a generic listener coupled to the ADRS system when the SPC system publishes results of an analysis of the processed lot; and
making a send SPC decision call, by the ADRS system, in response to the SPC system publishing the results, the send SPC decision call to trigger the ADRS system to store the published results from the SPC system in an ADRS database for use in future lookup recipe calls.

3. The method of claim 1, wherein the context of the lookup recipe call includes at least one of a product identification, a lot identification, a tool identification, and one or more operation identifications.

4. The method of claim 2, wherein the logic scripts utilize the ADRS database to reference the results from past runs and the historical SPC system analysis results.

5. The method of claim 2, wherein the send SPC decision call compares both of a lookup valid data limit and a lookup fail process disposition limit to the SPC analysis results to determine whether a combination of the tool and the lot are to be marked as failed in the ADRS database.

6. The method of claim 5, wherein the logic scripts reference whether the combination of the tool and the lot are marked as failed in determining the unique recipe instruction set for the tool.

7. The method of claim 1, wherein the unique recipe instruction set is built in logical segments based on dynamic information obtained via the logic scripts, the dynamic information including the results from past runs information, the historical SPC system analysis results, and the context information.

8. The method of claim 7, wherein the logical segments are each based on different aspects of the dynamic information.

9. An apparatus, comprising:
a tool of a semiconductor manufacturing system to receive a lot for processing;
a host controller coupled to the tool to make a lookup recipe call to determine a unique recipe instruction set for the tool to run on the lot; and
an automated dynamic recipe generation and selection (ADRS) system to:
receive the lookup recipe call;
run, in response to the lookup recipe call, logic scripts to create the unique recipe instruction set, the logic scripts to utilize at least one of results from past runs associated with the tool, historical statistical process control (SPC) system analysis results, and a context of the lookup recipe call in order to create the unique recipe instruction set; and
return the unique recipe instruction set to the host controller in order for the host controller to instruct the tool accordingly.

10. The apparatus of claim 9, further comprising a generic listener coupled to SPC system and the ADRS system to determine when the SPC system publishes results of an analysis of the lot subsequent to processing of the lot by the tool.

11. The apparatus of claim 10, wherein the ADRS system makes a send SPC decision call in response to the generic listener informing the ADRS system of the SPC system publishing the results, the send SPC decision call to trigger the ADRS system to store the published results in an ADRS database for use in future lookup recipe calls.

12. The apparatus of claim 11, wherein the logic scripts utilize the ADRS database to reference the results from past runs and the historical SPC system analysis results.

13. The apparatus of claim 11, wherein the send SPC decision call compares both of a lookup valid data limit and a lookup fail process disposition limit to the SPC analysis results to determine whether a combination of the tool and the lot are to be marked as failed in the ADRS database.

14. The apparatus of claim 9, wherein the unique recipe instruction set is built in logical segments based on dynamic information obtained via the logic scripts, the dynamic information including the results from past runs information, the historical SPC system analysis results, and the context information.

15. An article of manufacture comprising a machine-readable medium including data that, when accessed by a machine, cause the machine to perform operations comprising:
receiving a lot at a tool of a semiconductor manufacturing system;
making, by a host controller for the tool, a lookup recipe call to an automated dynamic recipe generation and selection (ADRS) system;
running, by the ADRS system, logic scripts to create a unique recipe instruction set for the particular tool and lot, the logic scripts to utilize at least one of results from past runs associated with the tool, historical statistical process control (SPC) system analysis results, and a context of the lookup recipe call in order to create the unique recipe instruction set; and
returning the unique recipe instruction set to the host controller to be run by the tool on the lot.

16. The article of manufacture of claim 15, wherein the machine-accessible medium further includes data that cause the machine to perform further operations comprising:
sending processing results from running the lot on the tool to the SPC system;
determining by a generic listener coupled to the ADRS system when the SPC system publishes results of an analysis of the processed lot; and
making a send SPC decision call, by the ADRS system, in response to the SPC system publishing the results, the send SPC decision call to trigger the ADRS system to store the published results from the SPC system in an ADRS database for use in future lookup recipe calls.

17. The article of manufacture of claim 15, wherein the context of the lookup recipe call includes at least one of a product identification, a lot identification, a tool identification, and one or more operation identifications.

18. The article of manufacture of claim 16, wherein the send SPC decision call compares both of a lookup valid data limit and a lookup fail process disposition limit to the SPC analysis results to determine whether a combination of the tool and the lot are to be marked as failed in the ADRS database.

19. The article of manufacture of claim 15, wherein the unique recipe instruction set is built in logical segments based on dynamic information obtained via the logic scripts, the dynamic information including the results from past runs information, the historical SPC system analysis results, and the context information.

20. The article of manufacture of claim 19, wherein the logical segments are each based on different aspects of the dynamic information.
